(19) United States
(12) Patent Application Publication
(10) Pub. No.: US 2025/0150145 A1
(43) Pub. Date: May 8, 2025

(54) METHOD FOR OPERATING AN ANTENNA ARRANGEMENT, ANTENNA ARRANGEMENT AND ELECTRICAL DEVICE

(71) Applicant: Sivantos Pte. Ltd., Singapore (SG)

(72) Inventor: Julius KRIEG, Olpe (DE)

(21) Appl. No.: 18/939,961

(22) Filed: Nov. 7, 2024

(30) Foreign Application Priority Data
Nov. 7, 2023 (DE) 10 2023 211 025.3

(51) Int. Cl. H04B 7/06; H04B 17/318

(52) U.S. Cl. CPC H04B 7/063; H04B 7/0623; H04B 17/318

(57) ABSTRACT

A method operates an antenna arrangement having a main antenna and an auxiliary antenna. The main antenna and the auxiliary antenna are each adjustable with regard to a number of antenna parameters. The number of adjustable antenna parameters of the auxiliary antenna is higher than in the main antenna. While the main antenna is operated in a transmit and/or receive mode: at least one antenna parameter of the auxiliary antenna is changed, a measure characterizing the operation of the auxiliary antenna is determined, depending on the measure, the antenna parameters of the auxiliary antenna are converted into target antenna parameters for the main antenna, and the antenna parameters of the main antenna are adjusted during the transmit and/or receive mode using the target antenna parameters.

### CROSS-REFERENCE TO RELATED APPLICATION

This application claims the priority, under 35 U.S.C. § 119, of German Patent Application DE 10 2023 211 025.3, filed Nov. 7, 2023; the prior application is herewith incorporated by reference in its entirety.

### FIELD AND BACKGROUND OF THE INVENTION

The invention relates to a method for operating an antenna arrangement, containing a main antenna and an auxiliary antenna, wherein the main antenna and the auxiliary antenna are each adjustable with regard to a number of antenna parameters. The invention further relates to an antenna arrangement for carrying out the method and to an electrical device, in particular a hearing device, having such an antenna arrangement.

A hearing device generally refers to an electronic device that assists the ability of a person wearing the hearing device to hear. In particular, the invention relates to a hearing device that is configured to fully or partially compensate for a loss of hearing of a hearing-impaired user. Such a hearing device is also referred to as a “hearing aid” (HA). Additionally, there are hearing devices which protect or improve the ability of users with normal hearing to hear, for example are intended to facilitate an improved understanding of speech in complicated hearing situations. Such devices are also referred to as “Personal Sound Amplification Products” (PSAP for short). Finally, in the sense used herein, the term “hearing device” also includes headphones worn on or in the ear (wired or wireless and with or without active noise suppression), headsets, etc., as well as implantable hearing devices, such as cochlear implants.

Hearing devices in general, and hearing aids in particular, are usually configured to be worn on the head and here in particular in or on a an ear of the user, in particular as behind-the-ear (BTE) or in-the-ear (ITE) devices. With regard to their internal structure, hearing devices usually have at least one output transducer which converts an output audio signal supplied for the purpose of output into a signal perceptible to the user as sound, and outputs said signal to the user.

In most cases, the output transducer is in the form of an electro-acoustic transducer which converts the (electrical) output audio signal into airborne sound, wherein this output airborne sound is output into the auditory canal of the user. In the case of a hearing device worn behind the ear, the output transducer, which is also referred to as “receiver”, is usually integrated in a housing of the hearing device outside of the ear. The sound output by the output transducer is guided into the auditory canal of the user by means of a sound tube in this case. As an alternative thereto, the output transducer can also be arranged in the auditory canal, and consequently outside of the housing worn behind the ear. Such hearing devices are also referred to as RIC devices from the English term “Receiver In Canal”. Hearing devices that are worn in the ear and are dimensioned to be so small that they do not protrude beyond the auditory canal to the outside are also referred to as CIC devices (from the English term “Completely In Canal”).

In further embodiments, the output transducer may also be in the form of an electromechanical transducer, which converts the output audio signal into structure-borne sound (vibrations), with this structure-borne sound being emitted to the cranial bone of the user, for example. Furthermore, there are implantable hearing devices, in particular cochlear implants, and hearing devices whose output transducers directly stimulate the auditory nerve of the user.

In addition to the output transducer, a hearing device often has at least one (acusto-electrical) input transducer. During operation of the hearing device, the input transducer or each input transducer records airborne sound from the surroundings of the hearing device and converts this airborne sound into an input audio signal (i.e., an electrical signal which transports information about the ambient sound). This input audio signal—also referred to as a “recorded sound signal”—is usually output to the user himself in original or processed form, e.g. for implementing a so-called transparency mode in headphones, for active noise suppression or—e.g. in a hearing aid—for achieving an improved sound perception of the user.

In addition, a hearing device often has a signal processing apparatus (signal processor). In the signal processing apparatus, the input audio signal or each input audio signal is processed (i.e. modified with regard to its sound information). The signal processing apparatus outputs a correspondingly processed audio signal (also referred to as “output audio signal” or “modified sound signal”) to the output transducer and/or an external device.

Such hearing devices further comprise, for example, an electromagnetic receiver, for example an antenna element as an RF antenna, by means of which the hearing device can be coupled for signal purposes, for example, to an operating element (remote control) and/or to a further hearing device. The same antenna element is generally used to transmit and receive data for space reasons.

Hearing devices are preferably configured to be particularly space-saving and compact, so that they can be worn by a hearing device user as visually inconspicuously as possible. As a result, increasingly smaller hearing devices are produced, which have an increasingly higher wearing comfort, and are thus hardly noticed by a user when being worn on or in an ear. However, due to the thus reduced installation space, it is increasingly difficult to accommodate and/or install conventional antenna elements for wireless signal transmission in such hearing devices. Another problem is, for example, that variability and adjustability of a directivity of the antenna elements is desired for different transmission modes.

Situations for wireless connections to hearing devices or other portable electrical devices are complicated to characterize since shielding (e.g. the user's body, objects in the room), directional gain, radio-frequency noise, and interference from unwanted sources play a role, and this also depends in each case on a selected frequency band and the dynamic position of the user in the room. There is a desire here for a signal strength of the transmitted and/or received signals to be as high as possible with the minimum possible power consumption. Therefore, optimizing antenna configurations with simple approaches (i.e. a well-defined relationship between power/frequency/mode/geometry and resulting signal strength) does not yield optimal results in dynamic real situations.

While it is possible to fine-tune the operating parameters of an active (hearing device) antenna during a transmit and/or receive mode (e.g. during streaming), this is typically not possible with major parameter changes since, with major parameter changes, the transmit and/or receive mode can be interrupted, and a zero or reduced signal strength is usually not desired.

To solve this problem, antenna arrangements with an antenna pair are conceivable, for example, in which a first antenna is used to transmit data and a second antenna is used to determine antenna parameters that are applied to the first antenna when an acceptable signal strength is reached. The antennas of the antenna pair are identical in this case, and so the antenna parameters of the second antenna can be transferred directly to the first antenna. Advantageously, such an approach with two identical antennas is not suitable for hearing device applications due to the limited installation space.

### SUMMARY OF THE INVENTION

The invention is based on the object of specifying a particularly suitable method for operating an antenna arrangement. In particular, the intention is to optimize a ratio between signal strength and power consumption of an antenna in dynamic real situations. The invention is further based on the object of specifying a particularly suitable antenna arrangement for carrying out the method, and a particularly suitable electrical device.

With regard to the method, the object is achieved according to the invention with the features of the independent method claim and, with regard to the antenna arrangement, with the features of the independent antenna arrangement claim and, with regard to the device, with the features of the independent device claim. The dependent claims (subclaims) relate to advantageous configurations and developments. The advantages and configurations listed with regard to the method are also analogously transferable to the antenna arrangement and/or the hearing device and vice versa.

The conjunction “and/or” here and in the following is to be understood to mean that the features linked by means of this conjunction can be implemented both jointly and as alternatives to one another.

If method steps are described in the following, advantageous configurations for the antenna arrangement are obtained in particular by the fact that the latter is configured to carry out one or more of these method steps.

The method according to the invention is provided and suitable and configured for operating an antenna arrangement. The antenna arrangement contains at least one main antenna and at least one auxiliary antenna in this case. The main antenna is provided and configured in this case for a transmit and/or receive mode, i.e. for wireless signal or data transmission. The auxiliary antenna is provided and configured for determining optimized antenna parameters for the main antenna during operation of the main antenna. In particular, the auxiliary antenna captures or measures in the antenna mode measured values, on the basis of which the antenna parameters for the main antenna should be determined.

In contrast to the prior art, the main and auxiliary antennas are not identical or structurally identical according to the invention. The main and auxiliary antennas are therefore configured as different antennas.

The main antenna is in particular an antenna which is suitable for streaming, for example a 2.4 GHz antenna, preferably a Wifi, Bluetooth, or ultra-wideband antenna.

For example, the auxiliary antenna or its design or construction is the product of an evolving algorithm which enables a high degree of variability together with a small form factor. The algorithm has nothing to do with the operation of the auxiliary antenna, but only determines its form and geometry. For example, the auxiliary antenna is configured as a multifilar antenna. Both the high variability and the small form factor result in a reduced signal quality, for example a reduced signal strength, compared to the main antenna. However, the reduced signal quality does not hinder the auxiliary antenna, since it is not used directly to transmit data.

An “antenna parameter” here and in the following should be understood in particular as meaning various characteristic variables or settings of the respective antenna which serve as tuning parameters in order to optimize the (antenna) performance and electrical properties for a specific application. By changing or adjusting the antenna parameters, the method of operation and the suitability of the respective antenna (or part of it) can be adapted or changed in terms of frequency, directivity, polarization, gain and impedance.

The main antenna and the auxiliary antenna are each adjustable or variable in this case with regard to a number of antenna parameters, wherein the number of adjustable antenna parameters of the auxiliary antenna is higher than that of the main antenna. In other words, the number of adjustable antenna parameters for the auxiliary antenna is at least one greater than the number of adjustable antenna parameters of the main antenna. Preferably, the main antenna is adjustable with regard to at least two antenna parameters, but the auxiliary antenna is adjustable with regards to at least three antenna parameters. For example, the main antenna is adjustable with regard to 2 to 8, in particular 2 to 4, antenna parameters, but the auxiliary antenna is adjustable with regard to 3 to 100, in particular 5 to 20, antenna parameters.

The antenna parameters can be, for example, a geometric property, an electrical property, a tuning state, an operating parameter, or a connection to a power splitter or a power combiner.

An antenna parameter in the form of a changeable or adjustable geometric property of the respective antenna should be understood as meaning, for example, an antenna branch (antenna arm) which is connected or removed by means of a mechanical switch, an electrical switch or a semiconductor switch. Such a geometric property is in particular also the shape of an antenna branch or the entire antenna, which is formed by at least one movement (e.g. bending, rolling, twisting or shearing), which is changed by an actuator (e.g. an electroactive polymer, an electromagnetic switch). In addition, the geometric relationship between two antenna branches of an antenna can also be changed (e.g. relative position, relative orientation).

The change or variability in an electrical property as an antenna parameter is possible, for example, by inserting, removing or changing the value of an electrical component or a module having a plurality of electrical components. The electrical component is, for example, a reactance, a capacitance, an inductance, an (ohmic) resistor, or a diode that establishes an electrical connection between one or more antenna branches and/or a bias voltage/potential (e.g. ground).

An antenna parameter may also be a tuning state of a semiconductor varactor, a microelectromechanical system (MEMS, e.g. MEMS varactor), a switched reactive MEMS element, or a voltage-tunable capacitor, wherein the tuning or parameter setting is a bias voltage.

An operating parameter (e.g. a constant voltage, a frequency, a signal waveform, an amplitude) of a voltage source connected to a section of the antenna via an electrical element (e.g. a capacitance, a coil, or a resistor) can also be used as an antenna parameter.

Furthermore, the connection or disconnection of a power splitter or a power combiner to/from an antenna branch of the antennas can be used as an antenna parameter.

According to the method, at least one of the antenna or tuning parameters of the auxiliary antenna is changed during a transmit and/or receive mode of the main antenna, i.e. during active data transmission, for example during streaming. A measure characterizing the operation of the auxiliary antenna is determined using the changed parameter set.

Depending on this measure, the antenna parameters of the auxiliary antenna are then converted into target antenna parameters for the main antenna. For example, it is possible in this case for the characterizing measure to be compared with a stored threshold value, and for the antenna parameters to be converted into the target antenna parameters when the threshold value is reached or exceeded, wherein at least one antenna parameter of the auxiliary antenna is changed when the threshold value is undershot. It is equally conceivable, for example, for the characterizing measure to be determined for a plurality of different parameter sets of the auxiliary antenna, and for a parameter set to then be selected using the measure and converted into the target antenna parameters for the main antenna.

Finally, the antenna parameters of the main antenna are adjusted using the target antenna parameters during the transmit and/or receive mode, i.e. without any significant interruption in the latter. This means that a particularly suitable method for operating an antenna arrangement is implemented.

By using a highly variable auxiliary antenna to determine antenna parameters of a less variable main antenna, it is possible to perform comparatively large jumps in the antenna parameter space in real-time scenarios and complex radio-frequency environments without significantly interrupting or disrupting the main antenna operation. As a result, it is possible to optimize the ratio between signal strength and power consumption of the main antenna in dynamic real situations (e.g. interaction with the user's body, directional gain, RF noise, shielding, interference from unwanted sources, and movements of the user relative to the streaming source). In particular, it is possible to determine better antenna parameters live during the active antenna mode without the need for two fully developed (identical) antennas. For example, the ratio of signal strength and power consumption of the main antenna can therefore be optimized during operation.

The method according to the invention is therefore suitable in particular for applications in which the parameter optimization not only involves fine-tuning, but rather large jumps occur in the parameter space with many local optima. Furthermore, it is therefore possible to determine an optimal set of antenna parameters for the main antenna with more than one antenna parameter, even if gradient descent methods do not work.

Furthermore, it is thus possible to find a heuristic solution for the complex relationship between antenna parameters and the resulting antenna performance.

The method according to the invention is thus provided in particular for operating a pair of variable antennas, wherein the first antenna is the main antenna for transmitting data (e.g. for Bluetooth streaming), and wherein the second antenna is configured as an auxiliary antenna. For example, the auxiliary antenna has a smaller form factor than the main antenna, is highly variable, and therefore has a larger antenna parameter space than the main antenna. The auxiliary antenna is configured in particular as a receiver and is tuned or adjusted such that it registers communication from a signal source (streaming source) to the main antenna, but does not exchange handshakes or acknowledgments.

Whereas the main antenna is configured in particular as an active receiver in the antenna mode, a plurality of different tuning or antenna parameters are applied to the auxiliary antenna. For each tuning configuration of the auxiliary antenna, a characterizing measure is determined and the antenna parameters of the main antenna are adjusted or optimized. The main antenna can also be used to transmit a signal, instead of receiving it, using the same or a largely similar antenna parameter configuration as described. When the main antenna is in a transmit mode, the auxiliary antenna is not used to optimize the main antenna parameters. In other words, the auxiliary antenna is preferably operated only in a receive mode of the main antenna.

In particular, it should be noted in this case that the antenna parameters for the auxiliary antenna generally have nothing to do with the antenna parameters of the main antenna, since they originate from different parameter spaces according to the method, since the antennas have different geometries, for example. Therefore, the tuning of the main antenna can be optimized during the active antenna mode without the need for an installation-space-intensive auxiliary antenna.

The antenna parameters of the main antenna can be optimized in terms of the signal strength, the power consumption (in the transmit mode only), or a combination of these. Preferably, the antenna parameters of the main antenna are intended to allow an antenna mode of the main antenna in which the main antenna is still operational, even if individual parameters are adjusted. In addition, optimization is possible in respect of more complex measures, such as the robustness to external movements in a certain situation. The antenna arrangement is used in particular in a portable electrical device, and so external movements should influence the antenna settings as little as possible.

After the antenna parameters for the main antenna have been determined and applied, they can be fine-tuned, for example, by approaching a local optimum in the parameter space, which no longer causes large jumps in the antenna performance and also does not impair or interrupt the antenna mode. For example, a gradient descent method is used for fine-tuning.

In one advantageous embodiment, an environmental situation is captured during the antenna mode (transmit and/or receive mode) of the main antenna, wherein the at least one antenna parameter of the auxiliary antenna is adjusted depending on a current environmental situation.

An “environmental situation” here and in the following should be understood as meaning in particular physical, electrical, and electromagnetic conditions, as well as any influences that may affect the function of the main antenna and consequently the transmission and reception of signals. Such environmental situations may include, for example, proximity to other electronic devices, the presence of obstacles that could block signal paths, or fluctuations in the available frequency bands. When used in a portable electrical device, an “environmental situation” also relates to varying conditions close to the body, such as the position at or in the ear of the user and his movements for an electrical device configured as a hearing device.

By taking into account the respective environmental situation, the antenna parameters or antenna properties of the auxiliary antenna can be adjusted more easily with regard to an optimum signal quality and/or with regard to a reduction in interference and/or with regard to energy efficiency. The antenna parameters for the main antenna can therefore be determined more easily, more quickly and more reliably.

In a conceivable configuration, the environmental situation is captured using a motion sensor. This is advantageous in particular when used in a portable electrical device, such as a hearing device, since a motion sensor of the (hearing) device, for example an inertial sensor, can thus be used to dynamically adjust the antenna arrangement, that is to say the auxiliary antenna and subsequently the main antenna.

In one expedient development, the characterizing measure is determined using a test measurement. Thus, an antenna parameter set of the main antenna is determined using test measurements of the completely different auxiliary antenna. In order to determine the measure, the antenna arrangement thus carries out a test measurement in which the auxiliary antenna is operated in a transmit and/or receive mode with the adjusted or changed antenna parameters. As a test result, a signal strength of the auxiliary antenna, in particular a received signal strength, is measured in this case and used to determine the characterizing measure. A signal strength for the auxiliary antenna can be determined in this case at least partially on the basis of comparisons with received data from the main antenna, which can be used as the fundamental truth (Ground Truth).

According to the method, the main antenna is operated, for example, as a receiver for Bluetooth streaming in a (hearing) device. The auxiliary antenna, which has for example a smaller form factor, a higher degree of variability, and a generally poorer performance, is used for test measurements of the received signal strength on the basis of a plurality of different tuning parameters. These test measurements by the auxiliary antenna are used to determine the tuning parameters for the main antenna. This allows the ratio of signal strength to power consumption of the main antenna to be optimized during operation, in which case even large jumps in the antenna parameter space are possible without streaming interruptions.

Additionally or alternatively, signal quality measurements, such as signal strength measurements, can be calculated for the auxiliary antenna from reference registrations by the main antenna.

The multiplicity of different antenna parameter configurations for the auxiliary antenna can be preset or generated as part of a training process with historical data (e.g. recordings of the signal strength of the main antenna, position and orientation of a user in a room, recorded by a motion sensor). In one possible embodiment, the at least one antenna parameter of the auxiliary antenna is adjusted by a trained learning machine.

The measurements of the signal quality with the auxiliary antenna are preferably carried out with antenna parameters which are the result of a training process. This means that a specific set of parameters is already optimized for a specific scenario. This makes the measurements more meaningful than when using randomly selected antenna parameters. The training can generally take place, for example, for a specific antenna application (e.g. for a specific hearing device brand or model brand) or at least partially specifically for a user, in order to take into account the environment and anatomy of the user.

The idea behind this is that, in this development, the method can optimize the antenna performance in complex radio-frequency scenarios without getting stuck in local optima in the space of the antenna parameters. This works because the antenna parameters for the auxiliary antenna are optimized in such a way that measurements thus provide a very high information value about the complex radio-frequency environment (environmental situation) compared to untrained systems. The advantage over conventional antennas (antenna systems/apparatuses) is that the scanning can be carried out very quickly (a few milliseconds or less) with the auxiliary antenna, while the time-consuming task of finding useful tuning parameters for the auxiliary antenna is shifted to a training period that does not take place in real time or even a pre-calculated database. Deriving or converting tuning parameters for the main antenna from the test measurements is computationally fast or could even be performed on a server in real time, for example.

In one preferred embodiment, the learning machine is trained using the captured environmental situation, the changed antenna parameters of the auxiliary antenna, and the characterizing measure. The selection or adjustment of the tuning or antenna parameters for the auxiliary antenna may at least partially depend on the position of the user (orientation or location) in a room or relative to a streaming source. This is achieved in this embodiment by mapping the environmental situation, for example, data from the motion sensor (e.g. head movements registered by an accelerometer), and storing it/them together with test measurement settings (antenna parameters of the auxiliary antenna) and test measurement results (measured values for the signal strength or the characterizing measure derived therefrom).

A large number of parameters of the auxiliary antenna can be recorded for each environmental situation and used to train a learning machine, such as a neural network. This network can be used to determine antenna parameters of the auxiliary antenna and to compare them with the current environmental situation. Deviations in the antenna orientation, interference sources or similar parameters can thus be inferred by means of pattern recognition and the antenna parameters can be optimized in this regard in a timely manner. The learning machine is thus trained as part of the method.

In training, the antenna parameters of the auxiliary antenna, the environmental situation (or data from the motion sensor), and the resulting characterizing measure are transmitted to the learning machine which stores the corresponding training information. As soon as a sufficient amount of training information has been collected and the learning machine has been trained with it, it is then ready for the antenna parameter prediction, or has generated a corresponding model for the antenna arrangement in a respective environmental situation. The amount of training information or number considered sufficient in this case is initially immaterial. This can be determined, for example, from past antenna data or from corresponding experiments or tests.

An additional or further aspect of the invention provides for the antenna parameters of the auxiliary antenna to be converted into the target antenna parameters for the main antenna by means of a classifier and/or a processor and/or an external server. The target antenna parameters for the main antenna are thus determined depending on the characterizing measure, i.e., for example, depending on the (test) measurements with the auxiliary antenna, by means of a classifier (e.g. a neural network or a plurality of them), by means of a processor or a processing unit (e.g. rule-based, lookup table, generic database, user-specific database, predefined assignment function), or by an external server. The server option is possible since a processing time of several hundred to several thousand milliseconds is not critical, for example, for an application of the method in a portable device, such as a hearing device. A neural network or a processor with a database (e.g. on the device, on a telephone or on a server) thus determines an improved set of tuning parameters (target antenna parameters) for the main antenna depending on the measurement results with the auxiliary antenna.

The antenna arrangement according to the invention comprises a variable antenna pair with a main antenna and an auxiliary antenna, and a controller (that is to say a control unit) for carrying out a method described above.

The main antenna is designed in this case for the actual data transmission (e.g. for Bluetooth streaming) of the antenna arrangement, whereas the auxiliary antenna is provided and configured for determining optimized antenna parameters for the main antenna while the main antenna is in an antenna or data transmission mode (transmit and/or receive mode).

The controller is here generally configured—in terms of programming and/or circuitry—to carry out the method according to the invention described above. The controller is thus specifically configured to apply different tuning or antenna parameters to the auxiliary antenna, while the main antenna is configured in particular as an active receiver in the antenna mode, and to determine a characterizing measure for each tuning configuration, wherein, depending on the measure, the antenna parameters of the auxiliary antenna are converted into target antenna parameters of the main antenna, and wherein the antenna parameters of the main antenna are adjusted or optimized using the target antenna parameters.

In one preferred embodiment, the controller is formed at least in the core by a microcontroller having a processor and a data memory, in which the functionality for carrying out the method according to the invention is implemented in terms of programming in the form of operating software (firmware), with the result that the method—if necessary in interaction with a device user—is carried out automatically when the operating software is executed in the microcontroller. However, the controller can alternatively be formed within the scope of the invention by a non-programmable electronic component, such as an application-specific integrated circuit (ASIC) or by an FPGA (Field Programmable Gate Array), in which the functionality for carrying out the method according to the invention is implemented with circuitry means.

In one expedient embodiment, the main antenna and the auxiliary antenna differ in terms of a form factor and/or a degree of variability and/or an antenna performance. In other words, antennas that differ in terms of form factor, degree of variability, performance, and their respective tuning parameter space are used in the antenna arrangement. For example, the auxiliary antenna has a smaller form factor than the main antenna and a larger antenna parameter space than the main antenna. The auxiliary antenna is configured in particular as a receiver and is tuned or adjusted such that it registers communication from a signal source (streaming source) to the main antenna, but essentially does not exchange handshakes or acknowledgments with the signal source.

The electrical device according to the invention is, in particular, a portable or mobile device. The device has an antenna arrangement described above. The reduced form factor and reduced power requirement of the antenna arrangement is generally beneficial for all portable or mobile electrical devices that support streaming functions or applications.

For example, the portable device is a smartwatch or a medical sensor device. However, the device can also be in the form of a tablet or smartphone, for example.

In one conceivable embodiment, the device can be worn on a user's head. In this case, the device is, for example, an earbud, in particular a consumer electronics earbud, or headphones. The device may be in particular a portable audio device, wherein the data which are transmitted or can be transmitted by means of the antenna arrangement may be audio data, in particular.

In one preferred embodiment, the electrical device is designed as a hearing device. The hearing device is used in particular to treat a hearing-impaired user (hearing aid). The hearing device is present in particular in one of the designs mentioned at the outset, in particular as a BTE, RIC, ITE or CIC device. The hearing device may furthermore also be an implantable or vibrotactile hearing aid.

The hearing device is configured in this case to pick up sound signals from the environment and output them to the user. The hearing device has a (hearing) device housing in which, for example, an input transducer, a signal processing apparatus, and an output transducer are accommodated. The device housing is designed in such a way that it can be worn by the user on the head and near the ear, e.g. in the ear, on the ear or behind the ear.

The input transducer is designed to capture sound information from a sound source and convert it into an input signal. The sound information may be sound signals from the environment of the hearing device or the user (noises, sounds, speech, etc.), which are converted by means of the input transducer, for example an electro-acoustic transducer, in particular a microphone, into an electrical input signal (audio signal).

An electrical output signal (audio signal) is generated from the electrical input signal by modifying (processing, filtering) the input signal in the signal processing apparatus. The in particular electro-acoustic output transducer is configured, for example, as a (miniature) loudspeaker in order to generate an acoustic sound signal (output signal) based on the (modified, processed, filtered) output signal generated by the signal processing apparatus.

The antenna arrangement is, for example, part of a transceiver of the hearing device for transmitting data via a signaling connection with an external additional device, for example with a smartphone, or with a further hearing device in a binaural design. In one preferred embodiment, the antenna arrangement is designed for a Bluetooth or Wifi connection. In other words, the main antenna is used as a Bluetooth or Wifi antenna.

Other features which are considered as characteristic for the invention are set forth in the appended claims.

Although the invention is illustrated and described herein as embodied in a method for operating an antenna arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a hearing system with a hearing device having an antenna arrangement;

FIG. 2 is a flow diagram of a method for operating the antenna arrangement in a first embodiment; and

FIG. 3 is a flow diagram showing a second embodiment of the method.

Mutually corresponding parts and variables are always provided with the same reference signs in all the figures.

### DETAILED DESCRIPTION OF THE INVENTION

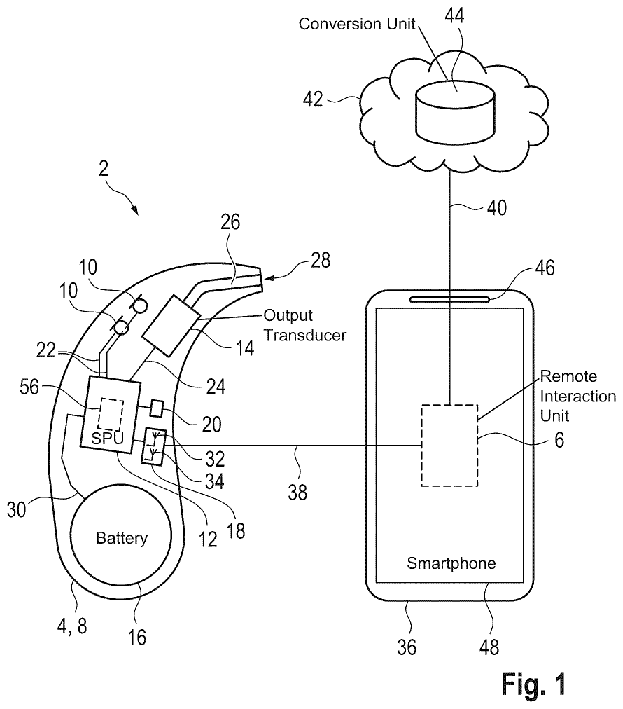

Referring now to the figures of the drawings in detail and first, particularly to FIG. 1 thereof, there is shown a schematic and simplified illustration of a hearing system 2 which is configured as a hearing aid device and contains an electrical device 4 configured as a hearing device and a remote interaction unit 6. The device 4 is hereinafter referred to as the hearing device 4. In the exemplary embodiment illustrated, the hearing device 4 is, by way of example, a BTE hearing device.

The hearing device 4 contains a (hearing device) housing 8 which is to be worn behind the ear of a hearing-impaired user and in which two input transducers 10 in the form of microphones, a signal processing apparatus 12, an output transducer 14 in the form of a receiver and a battery 16 are arranged as main components. The hearing device 4 further comprises a transceiver with an antenna arrangement 18 for exchanging data, in particular wirelessly, for example on the basis of a Bluetooth standard. The hearing device 4 optionally has a motion sensor 20, in particular an inertial sensor (Inertial Measurement Unit, IMU).

During operation of the hearing device 4, an ambient sound from the environment of the hearing device 4 is picked up by means of the input transducers 10 and is output to the signal processing apparatus 12 as an audio signal 22 (i.e. as an electrical signal carrying the sound information). The signal processing apparatus 12 processes the audio signal 22. The signal processing apparatus 12 for this purpose contains a multiplicity of signal processing functions, including an amplifier that is used to amplify the audio signal 22 in a frequency-dependent manner in order to compensate for the hearing impairment of the user.

The signal processing apparatus 12 outputs an audio signal 24 resulting from this signal processing to the output transducer 14. This in turn converts the audio signal 24 into an acoustic sound. This sound (modified in relation to the ambient sound picked up) is first transmitted from the output transducer 14 through a sound channel 26 to a tip 28 of the housing 8, and from there through a sound tube (not explicitly illustrated) to an earpiece that can be inserted or is inserted into the user's ear.

The signal processing apparatus 12 is supplied with electrical energy 30 from the battery 16.

The antenna arrangement 18 has a variable antenna pair with a main antenna 32 and an auxiliary antenna 34. The main antenna 32 and the auxiliary antenna 34 are each adjustable or variable in this case with regard to a number of antenna parameters, wherein the number of adjustable antenna parameters of the auxiliary antenna 34 is higher than that of the main antenna 32. The antenna arrangement 18 further contains a controller which is not shown in any more detail and can also be integrated, for example, in the signal processing apparatus 12 and is provided and configured for adjusting the antenna parameters of the auxiliary antenna 34 and the main antenna 32.

The main antenna 32 and the auxiliary antenna 34 are designed differently, and differ in particular in terms of a form factor and/or a degree of variability and/or an antenna performance. For example, the auxiliary antenna 34 has a smaller form factor than the main antenna 32 and a larger antenna parameter space than the main antenna.

The main antenna 32 is configured for the actual data transmission (e.g. for Bluetooth streaming) of the antenna arrangement 18, whereas the auxiliary antenna 34 is provided and configured for determining optimized antenna parameters for the main antenna 32 while the main antenna 32 is in an antenna or data transmission mode (transmit and/or receive mode).

For example, the auxiliary antenna 34 is the product of an evolving algorithm which has a high degree of variability together with a small form factor. For example, the auxiliary antenna is configured as a multifilar antenna. The auxiliary antenna 34 is configured in particular as a receiver and is tuned or adjusted such that it registers communication from a signal source (streaming source) to the main antenna 32, but does not exchange handshakes or acknowledgments with the signal source. In the exemplary embodiment, the signal source is in particular the remote interaction unit 6.

In the exemplary embodiment illustrated, the remote interaction unit 6 is implemented as software in the form of a (smartphone) app which is installed on a smartphone 36. In this case, the smartphone 36 can be a smartphone belonging to the hearing device user. The smartphone 36 is not itself a part of the hearing system 2 and is used by the latter only as a resource. Specifically, the remote interaction unit 6 uses storage space and computing power of the smartphone 36 to carry out a method described in more detail below for operating the hearing system 2 or the antenna arrangement 18. Furthermore, the remote interaction unit 6 uses a Bluetooth transceiver (not illustrated in more detail) of the smartphone 36 for wireless communication, i.e. for exchanging data with the hearing device 2 via a wireless signal or communication connection 38 (Bluetooth connection) to the antenna arrangement 18 that is indicated in FIG. 1.

Via a further wireless or wired data communication connection 40, for example based on the IEEE 802.11 standard (WLAN) or a mobile radio standard, e.g. LTE, the remote interaction unit 6 is further connected to a network, or to a data cloud (cloud) 42 which is arranged in the Internet and in which a conversion unit 44 is installed or integrated. The conversion unit 44 can also be integrated on a server coupled to the data cloud 42. For exchanging data with the conversion unit 44, the remote interaction unit 6 accesses a WLAN or mobile radio interface (also not explicitly illustrated) of the smartphone 36.

The smartphone 36 also has a loudspeaker 46 and a screen 48 in the form of a touchscreen. The loudspeaker 46 and/or the screen 48 is/are used by the remote interaction unit 6 as input and/or output means for the user.

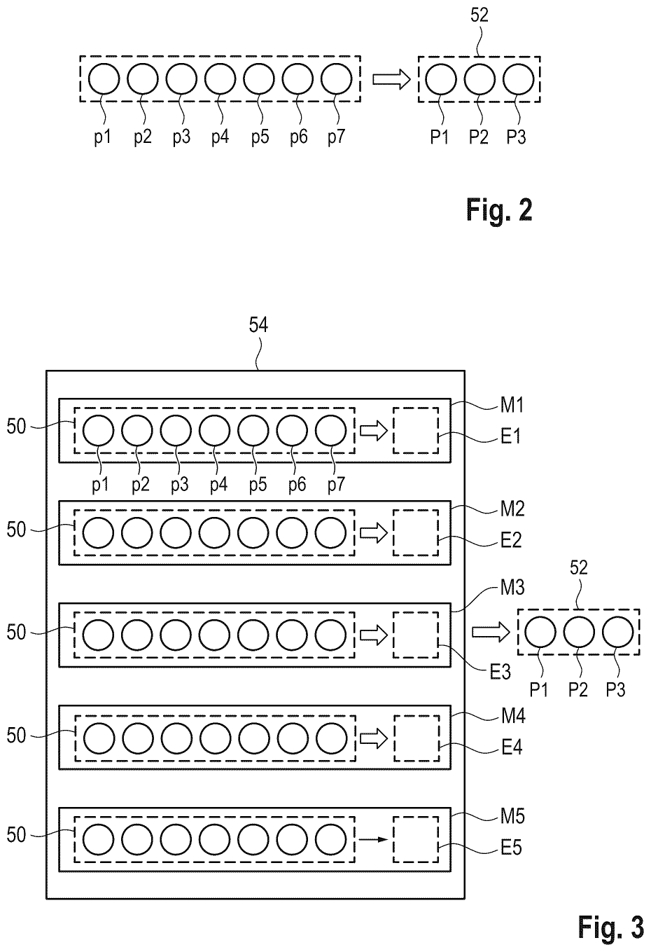

In the following, a method for operating the hearing system 2 in the form of a hearing apparatus or the antenna arrangement 18 is explained in more detail on the basis of FIG. 2.

In this exemplary embodiment, the auxiliary antenna 34 has, for example, a 7-dimensional parameter space, and accordingly an antenna configuration 50 with seven adjustable antenna or tuning parameters p1, p2, p3, p4, p5, p6, and p7. The parameter space of the main antenna 32 is here three-dimensional, for example, with the result that the main antenna 32 has an antenna configuration 52 with three adjustable antenna parameters P1, P2, and P3.

According to the method, at least one of the antenna parameters p1 to p7 of the auxiliary antenna 34 is changed during a transmit and/or receive mode of the main antenna 32, i.e. during an active data transmission via the communication connection 38, for example during streaming from the remote interaction unit 6 to the hearing device 4.

A measure characterizing the operation of the auxiliary antenna 34 is determined using the changed antenna configuration 50. Preferably, the measure or the antenna configuration 50 is optimized with regard to a desired antenna property (e.g. signal strength, directivity, signal power, energy/power consumption, . . . ). For example, the antenna configuration 50 shown in FIG. 2 is the result of an optimization process in which the antenna performance of the auxiliary antenna 34 was optimized or maximized as a measure.

The optimized antenna configuration 50 of the auxiliary antenna 34 is then converted into target antenna parameters or a target antenna configuration for the main antenna 32. The optimized antenna parameters p1 to p7 of the auxiliary antenna 34 are converted, for example, by means of a classifier and/or a processor. The classifier and/or the processor is/are part of the controller and is/are integrated, for example, in the signal processing apparatus 12 and/or in the remote interaction unit 6. In particular, the conversion of the antenna parameters p1 to p7 into the corresponding antenna parameters P1, P2, P3 is carried out by the conversion unit 44 in the data cloud 42 or on a server. The conversion unit 44 is configured in this case, for example, as a database or as a trained neural network which converts the greater number of auxiliary antenna parameters into corresponding main antenna parameters or main antenna parameters that have the same effect as far as possible.

According to the method, the target antenna parameters determined by this are set by the controller as new antenna parameters P1, P2, P3 of the main antenna 32. The antenna parameters P1, P2, P3 of the main antenna 32 are adjusted in this case during the active transmit and/or receive mode, i.e. without interrupting the latter.

In the following, a development of the method for operating the antenna arrangement 18 is explained in more detail on the basis of FIG. 3.

The optimization process for optimizing the antenna configuration 50 includes five consecutive test measurements M1, M2, M3, M4, M5 in this case. By way of example, the antenna parameters p1 to p7 in FIG. 3 are provided with reference signs only for the test measurement M1.

For each test measurement M1, M2, M3, M4, M5, at least one of the antenna parameters p1 to p7 of the antenna configuration 50 is changed. The actual test measurement is then carried out by operating the auxiliary antenna 34 with the changed antenna configuration 50. Preferably, the main antenna 32 is operated as a receiver for Bluetooth streaming via the communication connection 38. The auxiliary antenna 34 is configured as a receiver for the test measurement M1, M2, M3, M4, M5, and is tuned or adjusted such that it registers communication with the main antenna 32, but does not exchange handshakes or acknowledgements. As the test result (measurement result) E1, E2, E3, E4, E5, an antenna or signal property, for example a signal strength or a power consumption, is measured and used to determine the characterizing measure. The measure can be the test result E1, E2, E3, E4, E5 or a variable derived therefrom.

After the five test measurements M1, M2, M3, M4 and M5 have been carried out, a corresponding number of test results E1, E2, E3, E4, E5 or characteristic measures are available as a data set 54. The test results E1, E2, E3, E4, E5 or the characteristic measures are compared with each other with regard to the antenna or signal property to be optimized, and that antenna configuration 50 which provides the best result with regard to the antenna or signal property is selected. The selected antenna configuration 50 of the auxiliary antenna 34 is then converted into target antenna parameters or a target antenna configuration for the main antenna 32, and the antenna configuration 52 is adjusted accordingly.

After the antenna configuration 52 has been adjusted, the antenna parameters P1, P2, P3 can be fine-tuned, for example, by approaching a local optimum in the parameter space, which no longer causes large jumps in the antenna performance and also does not impair or interrupt the antenna mode of the main antenna 32.

In a further exemplary embodiment, an environmental situation of the hearing device 4 is captured during the antenna mode of the main antenna 32, wherein at least one of the antenna parameters p1 to p7 of the auxiliary antenna 34 is adjusted depending on a current environmental situation. The environmental situation is captured, for example, by means of the motion sensor 20 of the hearing device 4.

The multiplicity of different antenna parameter configurations 50 for the auxiliary antenna can be preset or generated as part of a training process with historical data (e.g. recordings of the signal strength of the main antenna, position and orientation of a user in a room, recorded by a motion sensor). In one possible embodiment, at least one of the antenna parameters p1 to p7 of the auxiliary antenna 34 is adjusted by a trained learning machine 56. The learning machine 56 may be integrated, for example, in the signal processing apparatus 12. Alternatively, the learning machine 56 may also be integrated in the remote interaction unit 6 and/or in the data cloud 42.

The test measurements M1, M2, M3, M4, M5 are preferably carried out with antenna parameters p1 to p7 which are the result of a training process. This means that a specific set of parameters or an antenna configuration 50 is already optimized for a specific scenario/environmental situation. In other words, for example, a test measurement M1 is carried out with the trained antenna configuration 50, and the remaining test measurements M2, M3, M4, M5 are carried out with antenna configurations 50 changed for this purpose. This allows the trained antenna configuration 50 to be optimized for a current environmental situation in each case.

Preferably, the learning machine 56 is continuously trained on the basis of the captured environmental situation, the changed antenna configuration 50 of the auxiliary antenna 34, and the resulting characterizing measure or the test result E1, E2, E3, E4, E5, and is thus individually adapted to a user, for example.

The claimed invention is not restricted to the above-described exemplary embodiments. On the contrary, other variants of the invention may also be derived herefrom by a person skilled in the art within the scope of the disclosed claims, without departing from the subject matter of the claimed invention. In particular, all the individual features described in connection with the various exemplary embodiments can furthermore also be combined in other ways within the scope of the disclosed claims, without departing from the subject matter of the claimed invention.

The following is a summary list of reference numerals and the corresponding structure used in the above description of the invention:
2 Hearing system
4 Device/hearing device
6 Remote interaction unit
8 Housing
10 Input transducer
12 Signal processing apparatus
14 Output transducer
16 Battery
18 Antenna arrangement
20 Motion sensor
22 Audio signal
24 Audio signal
26 Sound channel
28 Tip
30 Energy
32 Main antenna
34 Auxiliary antenna
36 Smartphone
38 Communication connection
40 Data communication connection
42 Data cloud
44 Conversion unit
46 Loudspeaker
48 Screen
50 Antenna configuration
52 Antenna configuration
54 Data set
56 Learning machine
p1, . . . , p7 Antenna parameter
P1, P2, P3 Antenna parameter
M1, . . . , M5 Test measurement
E1, . . . , E5 Test result

1. A method for operating an antenna configuration having a main antenna and an auxiliary antenna, wherein the main antenna and the auxiliary antenna are each adjustable with regard to a number of antenna parameters, wherein the number of adjustable antenna parameters of the auxiliary antenna is higher than in the main antenna, wherein while the main antenna is operated in a transmit and/or receive mode, the method comprises the following steps of:
changing at least one antenna parameter of the auxiliary antenna;
determining a characterizing measure characterizing an operation of the auxiliary antenna;
depending on the characterizing measure, converting the antenna parameters of the auxiliary antenna into target antenna parameters for the main antenna; and
adjusting the antenna parameters of the main antenna during the transmit and/or receive mode using the target antenna parameters.

2. The method according to claim 1, which further comprises:
capturing an environmental situation during the transmit and/or receive mode of the main antenna; and
adjusting the at least one antenna parameter of the auxiliary antenna in dependence on a current environmental situation.

3. The method according to claim 2, which further comprises capturing the environmental situation using a motion sensor.

4. The method according to claim 1, which further comprises determining the characterizing measure using a test measurement, in which the auxiliary antenna is operated in the transmit and/or receive mode, and in which the characterizing measure is determined from a measured signal strength.

5. The method according to claim 2, which further comprises adjusting the at least one antenna parameter of the auxiliary antenna by a trained learning machine.

6. The method according to claim 5, which further comprises training the learning machine using the environmental situation captured, changed antenna parameters of the auxiliary antenna, and the characterizing measure.

7. The method according to claim 1, which further comprises converting the antenna parameters of the auxiliary antenna into the target antenna parameters for the main antenna by means of a classifier, a processor, or an external server.

8. An antenna configuration, comprising:
a main antenna;
an auxiliary antenna, wherein said main antenna and said auxiliary antenna are each adjustable with regard to a number of antenna parameters, wherein the number of adjustable antenna parameters of said auxiliary antenna is higher than in said main antenna, and wherein said main antenna can be operated in a transmit and/or receive mode; and
a controller for carrying out the method according to claim 1.

9. The antenna configuration according to claim 8, wherein said main antenna and said auxiliary antenna differ in terms of a form factor and/or a degree of variability and/or an antenna performance.

10. An electrical device, comprising:
an antenna configuration, containing:
a main antenna;
an auxiliary antenna, wherein said main antenna and said auxiliary antenna are each adjustable with regard to a number of antenna parameters, wherein the number of adjustable antenna parameters of said auxiliary antenna is higher than in said main antenna, and wherein said main antenna can be operated in a transmit and/or receive mode; and
a controller for carrying out the method according to claim 1.

11. The electrical device according to claim 10, wherein the electrical device is a hearing device.
